(19) United States
(12) Patent Application Publication
(10) Pub. No.: US 2024/0220929 A1
(43) Pub. Date: Jul. 4, 2024

(54) APPARATUSES, COMPUTER-IMPLEMENTED METHODS, AND SYSTEMS FOR OUTPUTTING AN EXTERNAL SERVICE ALERT AGGREGATION INTERFACE COMPONENT IN ASSOCIATION WITH A PROJECT MANAGEMENT SYSTEM

(71) Applicants: ATLASSIAN PTY LTD., Sydney (AU); ATLASSIAN US, INC., San Francisco, CA (US)

(72) Inventor: Ankhil OJHA, Bangalore (IN)

(21) Appl. No.: 18/394,500

(22) Filed: Dec. 22, 2023

Related U.S. Application Data
(60) Provisional application No. 63/477,662, filed on Dec. 29, 2022.

(51) Int. Cl. G06Q 10/10; G06F 9/451

(52) U.S. Cl. CPC G06Q 10/103; G06F 9/451

(57) ABSTRACT

Methods, apparatuses, systems, and computer program products are disclosed for outputting an external service alert aggregation interface component in a project management system. In an example embodiment, an apparatus accesses a user identifier and a team identifier associated with a project management user interface comprising a plurality of team task interface components, causes retrieval of external service alert data from an external service alert data repository based on the user identifier and the team identifier, generates the external service alert aggregation interface component based on the external service alert data, and outputs the external service alert aggregation interface component for rendering to the project management user interface.

### CROSS-REFERENCE TO RELATED APPLICATIONS

The present application claims priority to and benefit of U.S. Provisional Patent Application No. 63/477,662, filed Dec. 29, 2022, the content of which is incorporated by reference in its entirety.

### BACKGROUND

Various methods, apparatuses, and systems provide tools allowing users to coordinate, plan, track, manage and/or otherwise monitor alerts and incidents within a project management system. Applicant has identified a number of deficiencies and problems in existing project management systems associated with efficiently providing updates on alerts and/or incidents, such as when developers are tracking development tasks on a scrum board. Through applied effort, ingenuity, and innovation, many of these identified deficiencies and problems have been solved by developing solutions that are structured in accordance with embodiments of the present disclosure, many examples of which are described in detail herein.

### BRIEF SUMMARY

In general, embodiments of the present disclosure provided herein include improved methods, apparatuses, systems, and computer program products configured for generating and outputting an external service alert aggregation interface component, in real time or near real time, in association with a project management system. In accordance with one exemplary embodiment of the present disclosure, an apparatus is provided for outputting an external service alert aggregation interface component in a project management system, the apparatus including at least one processor, and at least one non-transitory memory including program code, the at least one non-transitory memory and the program code configured to, with the at least one processor, cause the apparatus to access a user identifier and a team identifier associated with a project management user interface comprising a plurality of team task interface components, each of the team task interface components associated with the user identifier and the team identifier. In some embodiments, the program code is configured to cause the apparatus, via the at least one processor, to cause retrieval of external service alert data from an external service alert data repository based on the user identifier and the team identifier. In certain embodiments, the program code is configured to cause the apparatus, via the at least one processor, to generate the external service alert aggregation interface component based on the external service alert data. In still further embodiments, the program code is configured to cause the apparatus, via the at least one processor, to output the external service alert aggregation interface component for rendering to the project management user interface.

In certain embodiments, the external service alert data includes external service active alert data and external service active incident data.

In certain embodiments, the project management user interface includes a user identifier filter engagement component.

In some embodiments, in response to user engagement with the user identifier filter engagement component, the program code is configured to cause the apparatus, via the at least one processor, to cause retrieval of user focused external service alert data from the external service alert data repository or from the external service alert data based on the user identifier. In certain embodiments, the program code is further configured to cause the apparatus, via the at least one processor, to generate a user focused project management user interface comprising a plurality of user task interface components, each of the user task interface components associated with the user identifier. In still further embodiments, the program code is further configured to cause the apparatus, via the at least one processor, to generate a user focused external service alert aggregation interface component based on the user focused external service alert data. In certain embodiments, the program code is further configured to cause the apparatus, via the at least one processor, to output the user focused external service alert aggregation interface component for rendering to the user focused project management user interface.

In some embodiments, the external service alert aggregation interface component includes an external service active alert engagement component and an external service active incident engagement component.

In certain embodiments, in response to user engagement with the external service active alert engagement component or the external service active incident engagement component, the program code is configured to cause the apparatus, via the at least one processor, to generate an external service alert detail interface component based on the external service alert data. In some embodiments, the program code is further configured to cause the apparatus, via the at least one processor, to output the external service alert detail interface component for rendering to the project management user interface.

In some embodiments, the external service alert detail interface includes an alert list interface component and an alert details interface component.

In certain embodiments, the alert details interface component comprises an alert priority indicator component and an alert status indicator component.

In some embodiments, the list interface component includes one or more alert action engagement components each associated with an alert identifier, wherein in response to user engagement with a selected alert action engagement component, the program code is configured to cause the apparatus, via the at least one processor, to identify a selected alert identifier associated with the selected alert action engagement component. In certain embodiments, the program code is further configured to cause the apparatus to, via the at least one processor, cause retrieval of selected external service alert data from the external service alert data repository based on the selected alert identifier. In still further embodiments, the program code is further configured to cause the apparatus to, via the at least one processor, generate an external service alert modification interface component for rendering to the project management user interface.

In accordance with another exemplary embodiment of the present disclosure, a computer-implemented method includes accessing a user identifier and a team identifier associated with a project management user interface comprising a plurality of team task interface components, each of the team task interface components associated with the user identifier and the team identifier, causing retrieval of external service alert data from an external service alert data repository based on the user identifier and the team identifier, generating the external service alert aggregation interface component based on the external service alert data, and outputting the external service alert aggregation interface component for rendering to the project management user interface.

In some embodiments, the external service alert data includes external service active alert data and external service active incident data.

In certain embodiments, the project management user interface includes a user identifier filter engagement component.

In some embodiments, in response to user engagement with the user identifier filter engagement component, the computer-implemented method further comprises causing retrieval of user focused external service alert data from the external service alert data repository or from the external service alert data based on the user identifier, generating a user focused external service alert aggregation interface component based on the user focused external service alert data, and outputting the user focused external service alert aggregation interface component for rendering to the user focused project management user interface.

In certain embodiments, the external service alert aggregation interface component includes an external service active alert engagement component and an external service active incident engagement component.

In some embodiments, in response to user engagement with the external service active alert engagement component or the external service active incident engagement component, the computer-implemented method further comprises generating an external service alert detail interface component based on the external service alert data and outputting the external service alert detail interface component for rendering to the project management user interface.

In certain embodiments, the external service alert detail interface component includes an alert list interface component and an alert details interface component.

In some embodiments, the alert details interface component includes an alert priority indicator component and an alert status indicator component.

In certain embodiments, wherein the list interface component comprises one or more alert action engagement components each associated with an alert identifier, in response to user engagement with a selected alert action engagement component, the computer-implemented method further comprises identifying a selected alert identifier associated with the selected alert action engagement component, causing retrieval of selected external service alert data from the external service alert data repository based on the selected alert identifier, generating an external service alert modification interface component based on the selected external service alert data, and outputting the external service alert modification interface component for rendering to the project management user interface.

In accordance with another exemplary embodiment of the present disclosure, one or more non-transitory computer-readable media storing computer-executable instructions that, when executed by one or more processors, are configured to access a user identifier and a team identifier associated with a project management user interface comprising a plurality of team task interface components, each of the team task interface components associated with the user identifier and the team identifier. The non-transitory computer-readable storage medium of an example embodiment also includes computer instructions configured, upon execution, to cause retrieval of external service alert data from an external service alert data repository based on the user identifier and the team identifier. The non-transitory computer-readable storage medium of an example embodiment also includes computer instructions configured, upon execution, to generate the external service alert aggregation interface component based on the external service alert data. The non-transitory computer-readable storage medium of an example embodiment also includes computer instructions configured, upon execution, to output the external service alert aggregation interface component for rendering to the project management user interface.

In some embodiments, the external service alert data includes external service active alert data and external service active incident data.

In certain embodiments, the project management user interface includes a user identifier filter engagement component.

In some embodiments, in response to user engagement with the user identifier filter engagement component, the non-transitory computer-readable storage medium also includes computer instructions configured, upon execution, to cause retrieval of user focused external service alert data from the external service alert data repository or from the external service alert data based on the user identifier. The non-transitory computer-readable storage medium of an example embodiment also includes computer instructions configured, upon execution, to generate a user focused project management user interface comprising a plurality of user task interface components, each of the user task interface components associated with the user identifier. The non-transitory computer-readable storage medium of an example embodiment also includes computer instructions configured, upon execution, to generate a user focused external service alert aggregation interface component based on the user focused external service alert data. The non-transitory computer-readable storage medium of an example embodiment also includes computer instructions configured, upon execution, to output the user focused external service alert aggregation interface component for rendering to the user focused project management user interface.

In certain embodiments, the external service alert aggregation interface component comprises an external service active alert engagement component and an external service active incident engagement component.

In some embodiments, in response to user engagement with the external service active alert engagement component or the external service active incident engagement component, the non-transitory computer-readable storage medium also includes computer instructions configured, upon execution, to generate an external service alert detail interface component based on the external service alert data. The non-transitory computer-readable storage medium of an example embodiment also includes computer instructions configured, upon execution, to output the external service alert detail interface component for rendering to the project management user interface.

In certain embodiments, the external service alert detail interface component includes an alert list interface component and an alert details interface component.

In some embodiments, the alert details interface component includes an alert priority indicator component and an alert status indicator component.

In certain embodiments, wherein the list interface comprises one or more alert action engagement components each associated with an alert identifier, and wherein in response to user engagement with a selected alert action engagement component, the non-transitory computer-readable storage medium also includes computer instructions configured, upon execution, to identify a selected alert identifier associated with the selected alert action engagement component. The non-transitory computer-readable storage medium of an example embodiment also includes computer instructions configured, upon execution, to cause retrieval of selected external service alert data from the external service alert data repository based on the selected identifier. The non-transitory computer-readable storage medium of an example embodiment also includes computer instructions configured, upon execution, to generate an external service alert modification interface component based on the selected external service alert data. The non-transitory computer-readable storage medium of an example embodiment also includes computer instructions configured, upon execution, to output the external service alert modification interface component for rendering to the project management user interface.

In some embodiments, an apparatus is provided that comprises means for accessing a user identifier and a team identifier associated with a project management user interface comprising a plurality of team task interface components, each of the team task interface components associated with the user identifier and the team identifier. The apparatus of an example embodiment further comprises means for causing retrieval of external service alert data from an external service alert data repository based on the user identifier and the team identifier. The apparatus of an example embodiment further comprises means for generating the external service alert aggregation interface component based on the external service alert data. The apparatus of an example embodiment further comprises means for outputting the external service alert aggregation interface component for rendering to the project management user interface.

In certain embodiments, the external service alert data includes external service active alert data and external service active incident data.

In some embodiments, the project management user interface includes a user identifier filter engagement component.

In certain embodiments, in response to user engagement with the user identifier filter engagement component, the apparatus further comprises means for causing retrieval of user focused external service alert data from the external service alert data repository or from the external service alert data based on the user identifier. The apparatus of an example embodiment further comprises means for generating a user focused project management user interface comprising a plurality of user task interface components, each of the user task interface components associated with the user identifier. The apparatus of an example embodiment further comprises means for generating a user focused external service alert aggregation interface component for rendering to the user focused project management user interface. The apparatus of an example embodiment further comprises means for outputting the user focused external service alert aggregation interface component for rendering to the user focused project management user interface.

In some embodiments, the external service alert aggregation interface component includes an external service active alert engagement component and an external service active incident engagement component.

In certain embodiments, in response to user engagement with the external service active alert engagement component or the external service active incident engagement component, the apparatus further comprises means for generating an external service alert detail interface component based on the external service alert data. The apparatus of an example embodiment further comprises means for outputting the external service alert detail interface component for rendering to the project management user interface.

In some embodiments, the external service alert detail interface component includes an alert list interface component and an alert details interface component.

In some embodiments, the alert details interface component comprises an alert priority indicator component and an alert status indicator component.

In certain embodiments, wherein the list interface component comprises one or more alert action engagement components each associated with an alert identifier, and wherein in response to user engagement with a selected alert action engagement component, the apparatus further comprises means for identifying a selected alert identifier associated with the selected alert action engagement component. The apparatus of an example embodiment further comprises means for causing retrieval of selected external service alert data from the external service alert data repository based on the selected alert identifier. The apparatus of an example embodiment further comprises means for generating an external service alert modification interface component based on the selected external service alert data. The apparatus of an example embodiment further comprises means for outputting the external service alert modification interface component for rendering to the project management user interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings.

FIG. 1 illustrates an example project management system configured to communicate with one or more client devices in accordance with some example embodiments described herein;

FIG. 2 is a schematic block diagram of example circuitry for use in an external service alert aggregation interface component server in accordance with some example embodiments described herein;

FIG. 3 illustrates an example external service alert aggregation interface component structured in accordance with some example embodiments described herein;

FIG. 4A illustrates an example external service alert detail interface component structured in accordance with some example embodiments described herein;

FIG. 4B illustrates an alternative example external service alert detail interface component structured in accordance with some example embodiments described herein;

FIG. 5 is a flowchart illustrating example operations for outputting an external service alert aggregation interface component for rendering to a project management user interface in accordance with some example embodiments described herein;

FIG. 6 is a flowchart illustrating example operations for outputting a user focused external service alert aggregation interface component for rendering to a user focused project management user interface in accordance with some example embodiments described herein;

FIG. 7 is a flowchart illustrating example operations for outputting an external service alert detail interface component for rendering to a project management user interface in accordance with some example embodiments described herein;

FIG. 8 is a flowchart illustrating example operations for outputting an external service alert modification interface component for rendering to a project management user interface in accordance with some example embodiments described herein;

FIG. 9 is a schematic block diagram of an example system architecture that may be used to generate an external service alert aggregation interface component in accordance with some example embodiments described herein;

FIG. 10 illustrates an example external service alert modification interface component structured in accordance with some example embodiments described herein.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Various embodiments of the present disclosure are directed to improved apparatuses, methods, systems, and computer program products for generating and outputting an external service alert aggregation interface component in a project management system. Managing agile project management sprints and workflows for software development teams can a difficult and dynamic task. Scrum board interfaces may be used to track and manage sprints for a particular project and/or project team. Scrum board interfaces may include columns for work that needs to be done, work that is in progress, and work that is complete.

While scrum board interfaces enable tracking of sprints and their associated progress, they typically do not enable monitoring of other important information that might shape or inform the completion of sprint related tasks. Software development teams are often working on sprints related to software applications, features, or services that are currently deployed. Such teams perform their work without any immediate real-time understanding of any contemporaneous alerts or incidents that may be generated in connection with such software applications, features, or services.

Indeed, software development teams generally have to navigate away from a scrum board interface to other external alert and incident management systems in order to better understand the real-time status of the application, feature, or service that forms the basis of their sprint related work. They must also navigate to other platforms to view, track, and take action on these alerts and incidents. In particular, actions related to incidents may be critical because they often indicate that an application, feature, or service is down or degraded. Incident response times and time to incident resolution are important metrics that should be optimized in any software development enterprise.

If a scrum board interface is siloed from associated data, such a scrum board interface has no way to access external service active alert data or external service active incident data. This prevents developers from viewing, tracking, or taking action based on such data when completing their sprint related development activities.

Various embodiments of the present disclosure are directed to an integrated project management user interface that is configured to provide software development teams with an improved scrum board interface for not only tracking the work in a sprint, but also for integrating alert and incident data from external alert and incident management systems through an external service alert aggregation interface component. Such improved scrum board interfaces are configured to enable software development teams to track all tasks that need to be done and monitor real-time alerts and incidents, without losing time while switching between platforms.

### Definitions

The term “project management system” refers to the software platform(s) and associated hardware configured to support, maintain, and manage a plurality of issues, tasks, workspaces, and all associated functionalities. Example project management systems comprise supporting server(s), repositor(ies), and client device(s), and in some embodiments, are further configured to engage with external resources and external applicants. One example projection management system is Jira Software™ by Atlassian®.

The term “project management user interface” refers to a graphical user interface of a project management system that is configured to enable users to view and engage with one or more issues, tasks, workspaces, and/or the project management system. A project management user interface is rendered to a client device based on data and instructions provided by the project management system. In some embodiments, such data and instructions are facilitated by a dedicated software application running on the client device. In other embodiments, such data and instructions are provided through a web browser running on the client device. A non-limiting example of a project management user interface includes a plurality of team task interface components.

The term “user identifier” refers to one or more items of data by which a user may be specifically identified within a project management system. For example, a user identifier may comprise one or more of ASCII text, encryption keys, identification certificates, a pointer, an IP address, a URL, a MAC address, a memory address, or other specific identifier, or combinations thereof.

The term “team identifier” refers to one or more items of data by which a team or team unit comprising one or individual users may be specifically identified within a project management system. For example, a team identifier may comprise one or more of ASCII text, encryption keys, identification certificates, a pointer, an IP address, a URL, a MAC address, a memory address, or other specific identifier, or combinations.

The terms “team” or “team unit” refer to a set of team members. In some embodiments, an “active” team or team unit refers to a team or team unit satisfying an activity threshold associated with a development unit, such that data associated with the team or team unit is used in predictions, estimations, and calculations of values associated with the development unit.

The term “external service alert aggregation interface component” refers to a graphical user interface or sub-interface of a project management system that is configured to display a number of external service active alerts and/or external service active incidents associated with a particular user identifier and a particular team identifier within a project management user interface. The external service alert aggregation interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. The external service alert aggregation interface component is generated based on external service alert data retrieved from an external service alert data repository based on a user identifier and a team identifier. The external service alert aggregation interface is outputted for rendering to a project management user interface.

The term “external service alert aggregation interface component server” refers to a software platform and associated hardware that is configured to manage the various external service alert aggregation interface components and associated functionality of the project management system. The external service alert aggregation interface component server is configured to display external service alert data and cause retrieval of such data from one or more data repositories (e.g., external service alert data repository). In some examples, the functionality of the external service alert aggregation interface component server may be provided via a single server or collection of servers having a common functionality. In some examples, the functionality of the external service alert aggregation interface component server may be segmented among a plurality of servers or collections of servers (e.g., a cloud networking environment, microservices, and/or the like) performing subsets of the described functionality of the external service alert aggregation interface component server.

The term “team task interface component” refers to a graphical user interface or sub-interface of a project management system that is configured to display a particular task associated with a particular user identifier and a particular team identifier within a project management user interface. The team task interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “external service alert data” refers to one or more items of data related to alerts associated with an external service, including but not limited to, user identifier(s), development unit identifier(s), team identifier(s), external service active alert data, external service active incident data, status identifier(s), description text component(s), priority level identifier(s), date created identifier(s) and or the like.

The term “external service alert data repository” refers to a location, such as a database stored on a memory device, which is accessible by one or more computing devices for retrieval and storage of external service alert data and other data associated with external service alert aggregation interface components. The external service alert data repository exists separately outside of the project management system and the project management user interface. For example, the external service alert data repository may include one or more of user identifier(s), development unit identifier(s), team identifier(s), external service active alert data, external service active incident data, status identifier(s), description text component(s), priority level identifier(s), date created identifier(s) and/or the like. In an example embodiment, the external service alert data repository is a dedicated device. In other example embodiments, the external service alert data repository is part of a larger repository. In one or more embodiments, the external service alert data repository is dynamically updated. In various embodiments, the external service alert data repository is encrypted to limit unauthorized access of the external service alert data.

The term “external service active alert data” refers to one or more items of data related to active alerts associated with an external service, including but not limited to, user identifier(s), development unit identifier(s), team identifier(s), external service active alert data, external service active incident data, status identifier(s), description text component(s), priority level identifier(s), date created identifier(s) and or the like. In some examples, active alerts are notifications for issues unrelated to the team task interface components of the project management user interface. In some embodiments, the active alerts relate to an error in the functionality of an outside application. In other embodiments, the active alerts relate to a status update for an outside application.

The term “external service active incident data” refers to one or more items of data related to active incidents associated with an external service, including but not limited to, user identifier(s), development unit identifier(s), team identifier(s), status identifier(s), description text component(s), priority level identifier(s), date created identifier(s) and or the like. In some examples, active incidents indicate that an external application, feature, or service is down. In other examples, active incidents indicate that an external application, feature, or service is substantially degraded. In various embodiments, active incidents relate to a user action responsive to an active alert.

The term “user identifier filter engagement component” refers to a graphical user interface or sub-interface of a project management system that is configured to respond to user engagement from a user associated with a particular user identifier. The user identifier filter engagement component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. The user identifier filter engagement component is configured to cause retrieval of user focused external service alert data in response to an engagement from a user, where the data retrieved is based on the user identifier associated with the user. In one or more embodiments, user focused external service alert data is retrieved from an external service alert data repository. This is advantageous in that new data is able to be retrieved from the external service alert data repository. In other embodiments, user focused external service alert data is retrieved from external service alert data based on a user identifier. This is advantageous in that rendering latency is reduced when no new server query is needed.

The term “user focused external service alert data” refers to one or more items of data related to alerts associated with an external service and a particular user identifier, including but not limited to, user identifier(s), development unit identifier(s), team identifier(s), external service active alert data, external service active incident data, status identifier(s), description text component(s), priority level identifier(s), date created identifier(s) and or the like. In some embodiments, user focused external service alert data is retrieved from previously retrieved external service alert data based on a user identifier. This is advantageous in that rendering latency is reduced when no new server query is needed. In other embodiments, user focused external service alert data is retrieved from an external service alert data repository. This is advantageous in that new data may be retrieved.

The term “user focused project management user interface” refers to a graphical user interface of a project management system that is configured to enable users to view and engage with one or more issues, tasks, workspaces, and/or the like that are associated with a particular user identifier. A user focused project management user interface is rendered to a client device based on data and instructions provided by the project management system. In some embodiments, such data and instructions are facilitated by a dedicated software application running on the client device. In other embodiments, such data and instructions are provided through a web browser running on the client device. A non-limiting example of a user focused project management user interface includes a plurality of user task interface components.

The term “user task interface component” refers to a graphical user interface or sub-interface of a project management system that is configured to display a particular task associated with a particular user identifier within a project management user interface. The user task interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “user focused external service alert aggregation interface component” refers to a graphical user interface or sub-interface of a project management system that is configured to display a number of external service active alerts and/or external service active incidents associated with a particular user identifier within a project management user interface. The user focused external service alert aggregation interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. The user focused external service alert aggregation interface component is generated based on user focused external service alert data. The user focused external service alert aggregation interface is outputted for rendering to a user focused project management user interface.

The term “external service active alert engagement component” refers to a graphical user interface or sub-interface of a project management system that is configured to respond to user engagement with an external service alert aggregation interface component. The external service active alert engagement component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. In response to user engagement, the external service active alert engagement component causes population of an external service alert detail interface component. The external service active alert engagement component is further configured to cause output of the external service alert detail interface component for rendering to a project management user interface.

The term “external service active incident engagement component” refers to a graphical user interface or sub-interface of a project management system that is configured to respond to user engagement an external service alert aggregation interface component. The external service active incident engagement component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. In response to user engagement, the external service active incident engagement component causes population of an external service alert detail interface component. The external service active incident engagement component is further configured to cause output of the external service alert detail interface component for rendering to a project management user interface.

The term “external service alert detail interface component” refers to a graphical user interface or sub-interface of a project management system that is configured to display detailed information about external service alert data in response to user engagement with an external service active alert engagement component or an external service alert active incident engagement component. The external service alert detail interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. The external service alert detail interface component is generated based on external service alert data retrieved from an external service alert data repository in response to user engagement with an external service alert aggregation engagement component. The external service alert detail interface component is output for rendering to a project management user interface. In one or more embodiments, the external service alert detail interface component comprises an alert list interface component and an alert details interface component.

The term “alert list interface component” refers to a graphical user interface or sub-interface of a project management system that is configured to display a list of external service active alerts or external service active incidents in an external service alert detail interface component. The alert list interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert details interface component” refers to a graphical user interface or sub-interface of a project management system that is configured to display details about particular external service active alerts or external service active incidents based on a user identifier and/or a team identifier in an external service alert detail interface component. The alert details interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert priority indicator component” refers to a graphical user interface or sub-interface of a project management system that is configured to indicate the priority of a particular external service active alert or external service active incident associated with a particular alert identifier in an alert details interface component. The alert priority indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert status indicator component” refers to a graphical user interface or sub-interface of a project management system that is configured to indicate the status of a particular external service active alert or external service active incident associated with a particular alert identifier in an alert details interface component. The alert status indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert reception quantity indicator component” refers to a graphical user interface or sub-interface of a project management system that is configured to indicate the number of times a particular external service active alert or external service active incident associated with a particular alert identifier has been received by particular users or teams in an alert details interface component. The alert reception quantity indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert identifier indicator component” refers to a graphical user interface or sub-interface of a project management system that is configured to indicate the alert identifier associated with a particular external service active alert or external service active incident in an alert details interface component. The alert identifier indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert responder indicator component” refers to a graphical user interface or sub-interface of a project management system that is configured to indicate the user or team responsible for responding to a particular external service active alert or external service active incident. The alert responder indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert acknowledgement indicator component” refers to a graphical user interface or sub-interface of a project management system that is configured to indicate users that have acknowledged a particular external service active alert or external service active incident. The alert acknowledgement indicator component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device.

The term “alert action engagement component” refers to a graphical user interface or sub-interface of a project management system that is configured to respond to user engagement with an alert list interface component within a project management user interface. The alert action engagement component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. In response to a user engagement, the alert action engagement component causes generation of an external service alert modification interface component based on selected external service alert data associated with a particular alert identifier.

The term “alert identifier” refers to one or more items of data by which a particular external service active alert or external service active incident may be identified within a project management system. For example, an alert identifier may comprise one or more of ASCII text, encryption keys, identification certificates, a pointer, an IP address, a URL, a MAC address, a memory address, or other specific identifier, or combinations thereof.

The term “selected external service alert data” refers to one or more items of data related to an external service alert associated with a particular alert identifier, including but not limited to, user identifier(s), development unit identifier(s), team identifier(s), external service active alert data, external service active incident data, status identifier(s), description text component(s), priority level identifier(s), date created identifier(s) and or the like.

The term “external service alert modification interface component” refers to a graphical user interface or sub-interface of a project management system that is configured to render a detailed display of selected external service alert data associated with a particular alert identifier within a project management user interface. The external service alert modification interface component is rendered to a client device based on data and instructions provided by the project management system (e.g., external service alert aggregation interface server). In some embodiments, the data and instructions are facilitated by a dedicated software application running on the client device. In other embodiments, the data and instructions are provided through a web browser running on the client device. In one or more embodiments, the external service alert modification interface component allows modification of selected external service alert data in response to user engagement.

The terms “client device”, “computing device”, “user device”, and the like may be used interchangeably to refer to computer hardware that is configured (either physically or by the execution of software) to access one or more of an application, service, or repository made available by a server (e.g., apparatus of the present disclosure) and, among various other functions, is configured to directly, or indirectly, transmit and receive data. The server is often (but not always) on another computer system, in which case the client device accesses the service by way of a network. Example client devices include, without limitation, smart phones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure.

The terms “data,” “content,” “digital content,” “digital content object,” “signal,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use computer-readable storage medium, other types of computer-readable mediums can be substituted for or used in addition to the computer-readable storage medium in alternative embodiments.

The terms “application,” “software application,” “app,” “product,” “service” or other similar terms refer to a computer program or group of computer programs designed to perform coordinated functions, tasks, or activities for the benefit of a user or group of users. A software application can run on a server or group of servers (e.g., physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “project management application” or “project management app” refer to a dedicated software program, application, platform, service, web browser, or computer-executable application software programmed or configured to run on a client device which provides the user access to the project management system and its associated functionality. In some embodiments, the project management application may include hardware, software, or combinations thereof operating remotely (e.g., on a server). In some embodiments, the project management application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems names above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

Having set forth a series of definitions called-upon throughout this application, an example system architecture and example apparatus is described below for implementing example embodiments and features of the present disclosure.

### Example System Architecture

Methods, apparatuses, systems, and computer program products of the present disclosure may be embodied by any of a variety of computing devices. For example, the method, apparatus, system, and computer program product of an example embodiment may be embodied by a networked device, such as a server or other network entity, configured to communicate with one or more devices, such as one or more client devices 101A-101N. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

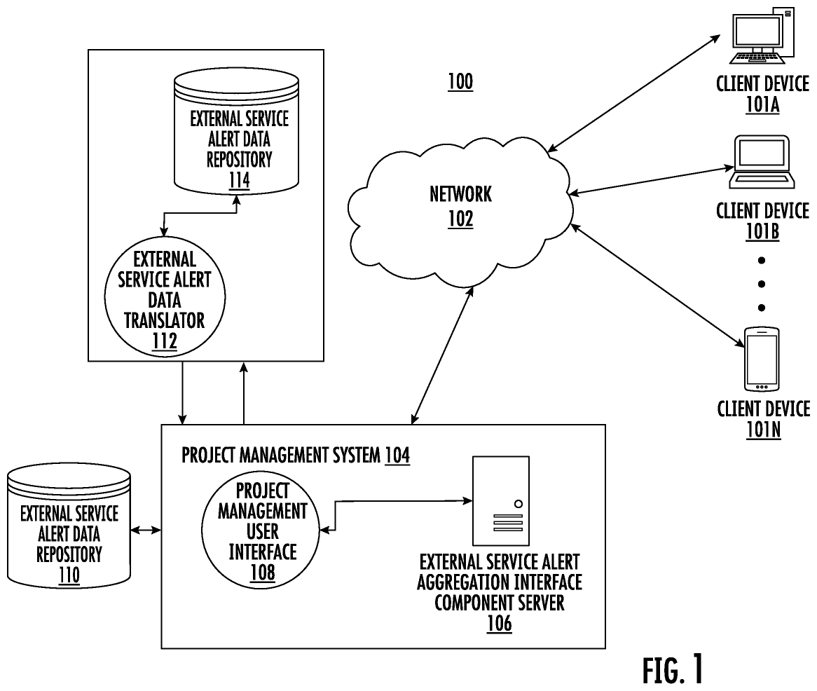

FIG. 1 depicts an example computing system 100 within which some embodiments of the present disclosure operate. In particular, FIG. 1 illustrates an example project management system 104 configured to communicate with one or more client devices 101A-101N in accordance with some example embodiments described herein. Users may access a project management system 104 via a communications network 102 using one or more of client devices 101A-101N. In this example embodiment, project management system 104 comprises an external service alert aggregation interface component server 106. The project management system 104 is, in some embodiments, able to generate and output an external service alert aggregation interface component 304 for rendering to project management user interface 108 associated with a user identifier and a team identifier, as will be described below.

In an example embodiment, the project management system 104 is in communication with an external service alert data repository 110. In this example embodiment, the external service alert data repository 110 contains external service alert data that is not in need of translation before being rendered in the project management user interface 108. In example embodiments, such external service alert data can be external service active alert data and/or external service active incident data. In this example embodiment, external service alert data is fetched from the external service alert data repository 110 based on list queries issued from the project management user interface 108. Such list queries may be based on information including but not limited to user identifier, team identifier, alert identifier, status, description, priority level, or data created.

In an example embodiment, the project management system 104 is in communication with an external service alert data repository 114 and/or an external service alert data translator 112. In this example embodiment, the external service alert data repository 114 contains external service alert data that is in need of translation, normalization, verification, and/or validation before being rendered in the project management user interface 108. In this example embodiment, the external service alert data is translated by the external service alert data translator 112 before being rendered in the project management user interface 108. In example embodiments, such external service alert data can be external service active alert data and/or external service active incident data. In this example embodiment, external service alert data is fetched from the external service alert data repository 114 based on list queries issued from the project management user interface 108. Such list queries may be based on information including but not limited to user identifier, team identifier, alert identifier, status, description, priority level, or data created.

External service alert aggregation interface component server 106 may include circuitry, networked processors, or the like configured to perform some or all of the external service alert aggregation interface component server-based processes described herein (e.g., detecting user engagements, generating and/or transmitting commands and instructions for rendering an external service alert aggregation interface component 304 to one or more client devices 101A-101N, using data from, for example external service alert data repository 110 or external service alert data repository 114), and may be any suitable network server and/or other type of processing device. In this regard, the external service alert aggregation interface component server 106 may be embodied by any of a variety of devices, for example, the external service alert aggregation interface component server 106 may be embodied as a computer or a plurality of computers. For example, external service alert aggregation interface component server 106 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals.

In example embodiments, external service alert aggregation interface component server 106 may be located remotely from external service alert data repository 110 and/or external service alert data repository 114. The external service alert aggregation interface component server 106 may, in some embodiments, comprise several servers or computing devices performing interconnected and/or distributed functions. Despite the many arrangements contemplated herein, external service alert aggregation interface component server 106 is shown and described herein as a single computing device to avoid unnecessarily complicating the disclosure.

External service alert aggregation interface component server 106 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of project management system 104.

External service alert data repository 110 and/or external service alert data repository 114 may be stored in any suitable storage device configured to store some or all of the information described herein (e.g. one or more database systems, backend data servers, network databases, cloud storage devices, or the like provided by another device (e.g., online application or 3rd party provider), such as a Network Attached Storage (NAS) device or devices, or as a separate database server or servers). External service alert data repository 110 and/or external service alert data repository 114 may comprise data received from an external service alert platform, and the corresponding storage device may thus store this data.

In example embodiments, the external service alert platform may comprise an external service active alert management system. In one or more example embodiments, the external service alert platform may comprise an external service active incident management system. External service alert data repository 110 and/or external service alert data repository 114 includes information accessed and stored by the external service alert aggregation interface component server 106 to facilitate the operations of the project management system 104. As such, external service alert data repository 110 and/or external service alert data repository 114 may include, for example, without limitation, user identifier(s), team identifier(s), alert identifier(s), priority indicator(s), status indicator(s), description(s), date(s) created, and/or the like.

The client devices 101A-101N may be implemented as any computing device as defined above. That is, the client devices 101A-101N may also include circuitry, networked processors, or the like configured to perform some or all of the apparatus-based processes described herein and may include a suitable network server and/or other type of processing device (e.g., a controller or computing device of the client devices 101A-101N). Electronic data received by the external service alert aggregation interface component server 106 from the client devices 101A-101N may be provided in various forms and via various methods. For example, the client devices 101A-101N may include desktop computers, laptop computers, smartphones, netbooks, tablet computers, wearables, and/or other networked devices, that may be used for any suitable purpose in addition to presenting the collaborative contextual summary interface to a user and otherwise providing access to the project management system 104. The depictions in FIG. 1 of “N” client devices are merely for illustration purposes. According to some embodiments, the client devices 101A-101N may be configured to display an interface on a display of the client device 101A-101N for viewing, editing, and/or otherwise interacting with at least one external service alert aggregation interface component 304, which may be provided by the project management system 104.

In embodiments where a client device 101A-101N is a mobile device, such as a smartphone or tablet, the client device 101A-101N may execute an “app” to interact with the project management system 104. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the project management system 104 via a web browser. As yet another example, the client devices 101A-101N may include various hardware or firmware designed to interface with the project management system 104.

### Example Apparatus for Implementing Embodiments of the Present Disclosure

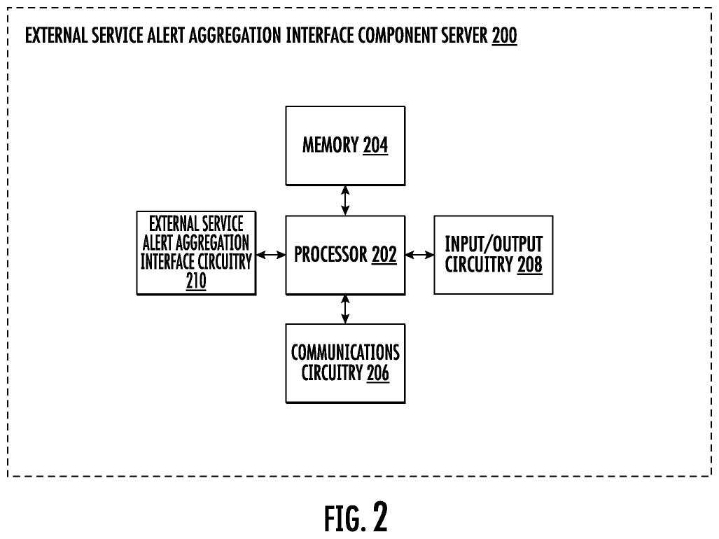

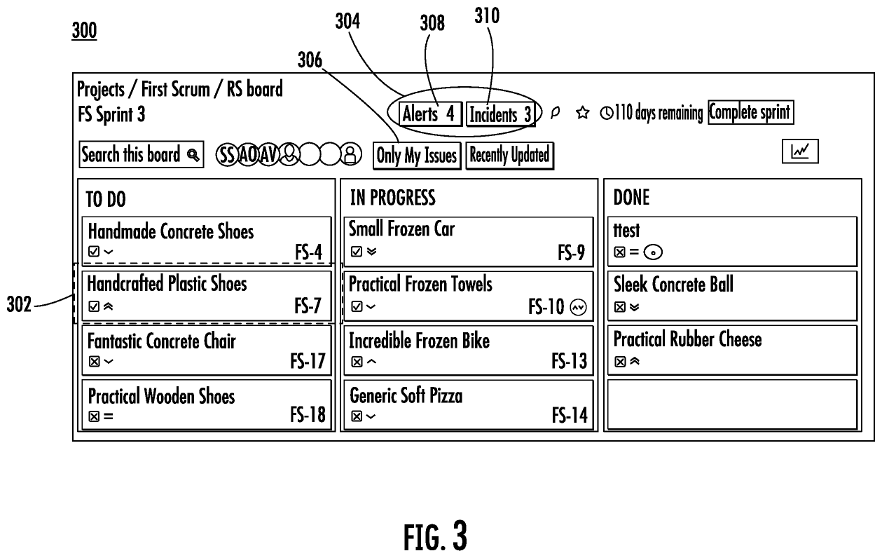

FIG. 2 shows a schematic block diagram of example circuitry, some or all of which may be included in an external service alert aggregation interface component server 200. In accordance with some example embodiments, external service alert aggregation interface component server 200 may include various means, such as memory 204, processor 202, input/output circuitry 208, and/or communications circuitry 206. Moreover, in some embodiments, external service alert aggregation interface circuitry 210 may also or instead be included in the external service alert aggregation interface component server 200. For example, when external service alert aggregation interface circuitry 210 is included in external service alert aggregation interface component server 200, external service alert aggregation interface circuitry 210 may be configured to facilitate the functionality discussed herein regarding accessing a user identifier and/or a team identifier, causing retrieval of external service alert data, and generating and/or outputting an external service alert aggregation interface component 304. An apparatus, such as external service alert aggregation interface component server 200, may be configured, using one or more of the circuitry 202, 204, 206, 208, and 210, to execute the operations described above with respect to FIG. 1 and below in connection with FIGS. 3-10.

Although the use of the term “circuitry” as used herein with respect to components 202-210 are described in some cases using functional language, it should be understood that the particular implementations necessarily include the use of particular hardware configured to perform the functions associated with the respective circuitry as described herein. It should also be understood that certain of these components 202-210 may include similar or common hardware. For example, two sets of circuitry may both leverage use of the same processor, network interface, storage medium, or the like to perform their associated functions, such that duplicate hardware is not required for each set of circuitry. It will be understood in this regard that some of the components described in connection with the external service alert aggregation interface component server 200 may be housed within this device, while other components are housed within another of these devices, or by yet another device not expressly illustrated in FIG. 1.

While the term “circuitry” should be understood broadly to include hardware, in some embodiments, the term “circuitry” also includes software for configuring the hardware. For example, in some embodiments, “circuitry” may include processing circuitry, storage media, network interfaces, input/output devices, and the like. In some embodiments, other elements of the external service alert aggregation interface component server 200 may provide or supplement the functionality of particular circuitry. For example, the processor 202 may provide processing functionality, the memory 204 may provide storage functionality, the communications circuitry 206 may provide network interface functionality, and the like.

In some embodiments, the processor 202 (and/or co-processor or any other processing circuitry assisting or otherwise associated with the processor 202) may be in communication with the memory 204 via a bus for passing information among components of, for example, external service alert aggregation interface component server 200. The memory 204 is non-transitory and may include, for example, one or more volatile and/or non-volatile memories, or some combination thereof. In other words, for example, the memory 204 may be an electronic storage device (e.g., a non-transitory computer readable storage medium. The memory 204 may be configured to store information, data, content, applications, instructions, or the like, for enabling an apparatus, e.g., external service alert aggregation interface component server 200, to carry out various functions in accordance with example embodiments of the present disclosure.

Although illustrated in FIG. 2 as a single memory, memory 204 may comprise a plurality of memory components. The plurality of memory components may be embodied on a single computing device or distributed across a plurality of computing devices. In various embodiments, memory 204 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 204 may be configured to store information, data, applications, instructions, or the like for enabling external service alert aggregation interface component server 200 to carry out various functions in accordance with example embodiments discussed herein. For example, in at least some embodiments, memory 204 is configured to buffer data for processing by processor 202. Additionally or alternatively, in at least some embodiments, memory 204 is configured to store program instructions for execution by processor 202. Memory 204 may store information in the form of static and/or dynamic information. This stored information may be stored and/or used by external service alert aggregation interface component server 200 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as external service alert aggregation interface component server 200. The plurality of processors may be in operative communication with each other and may be collectively configured to perform one or more functionalities of external service alert aggregation interface component server 200 as described herein.

In an example embodiment, processor 202 is configured to execute instructions stored in the memory 204 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions when executed by processor 202, may cause external service alert aggregation interface component server 200 to perform one or more of the functionalities of external service alert aggregation interface component server 200 as described herein.

In some embodiments, external service alert aggregation interface component server 200 further includes input/output circuitry 208 that may, in turn, be in communication with processor 202 to provide an audible, visual, mechanical, or other output and/or, in some embodiments, to receive an indication of an input from a user, a client device 101A-101N, or another source. In that sense, input/output circuitry 208 may include means for performing analog-to-digital and/or digital-to-analog data conversions. Input/output circuitry 208 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric sensor (e.g., accelerometer and/or gyroscope), microphone, audio recorder, speaker, biometric scanner, and/or other input/output mechanisms. Input/output circuitry 208 may comprise a user interface and may comprise a web user interface, a mobile application, a kiosk, or the like. The processor 202 an/or user interface circuitry comprising the processor 202 may be configured to control one or more functions of a display or one or more user interface elements through computer program instructions (e.g., software and/or firmware) stored on a memory accessible to the processor 202 (e.g., memory 204, and/or the like).

In some embodiments, aspects of input/output circuitry 208 may be reduced as compared to embodiments where external service alert aggregation interface component server 200 may be implemented as an end-user machine or other type of device designed for complex user interactions. In some embodiments (like other components discussed herein), input/output circuitry 208 may even be eliminated from external service alert aggregation interface component server 200. Input/output circuitry 208 may be in communication with memory 204, communications circuitry 206, and/or any other component(s), such as via a bus. Although more than one input/output circuitry and/or other component can be included in external service alert aggregation interface component server 200, only one is shown in FIG. 2 to avoid overcomplicating the disclosure (e.g., like the other components discussed herein).

Communications circuitry 206, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with external service alert aggregation interface component server 200. In this regard, communications circuitry 206 may include, for example, a network interface for enabling communications with a wired or wireless communication network. For example, in some embodiments, communications circuitry 206 is configured to receive and/or transmit any data that may be stored by memory 204 using any protocol that may be used for communications between computing devices. For example, communications circuitry 206 may include one or more network interface cards, antennac, transmitters, receivers, buses, switches, routers, modems, and supporting hardware and/or software, and/or firmware/software, or any other device suitable for enabling communications via a network. Additionally or alternatively, in some embodiments, communications circuitry 206 includes circuitry for interacting with the antenna(e) to cause transmission of signals via the antenna(e) or to handle receipt of signals received via the antenna(e). These signals may be transmitted by external service alert aggregation interface component server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 206 may additionally or alternatively be in communication with the memory 204, input/output circuitry 208 and/or any other component of external service alert aggregation interface component server 200, such as via a bus.

In some embodiments, external service alert aggregation interface circuitry 210 may also or instead be included and configured to perform the functionality discussed herein related to, inter alia, accessing a user identifier and/or a team identifier, causing retrieval of external service alert data, and generating and/or outputting an external service alert aggregation interface component(s) 304. In some embodiments, external service alert aggregation interface circuitry 210 includes hardware, software, firmware, and/or a combination of such components, configured to support various aspects of such external service alert aggregation interface-related functionality, features, and/or services of the external service alert aggregation interface component server 200 as described herein (e.g., designed to generate and output an external service alert aggregation interface component 304 based at least on external service alert data retrieved from external service alert data repository 110 and/or external service alert data repository 114). It should be appreciated that in some embodiments, external service alert aggregation interface circuitry 210 performs one or more of such exemplary actions in combination with another set of circuitry of the external service alert aggregation interface component server 200, such as one or more of memory 204, processor 202, input/output circuitry 208, and communications circuitry 206. For example, in some embodiments, external service alert aggregation interface circuitry 210 utilizes processing circuitry, such as the processor 202 and/or the like, to perform one or more of its corresponding operations. In a further example, in some embodiments, some or all of the functionality of external service alert aggregation interface circuitry 210 may be performed by processor 202. In this regard, some or all of the example processes and algorithms discussed herein can be performed by at least one processor 202 and/or external service alert aggregation interface circuitry 210. It should be appreciated that, in some embodiments, external service alert aggregation interface circuitry 210 may include a separate processor, specially configured field programmable gate array (FPGA), or application specific integrated circuit (ASIC) to perform its corresponding functions.

Additionally or alternatively, in some embodiments, external service alert aggregation interface circuitry 210 includes hardware, software, firmware, and/or a combination thereof, that interacts with external service alert data repository 110, external service alert data repository 114, and/or memory 204 to send, retrieve, update, and/or store data values embodied by and/or associated with an external service alert aggregation interface component 304 including, but not limited to, user identifier(s), team identifier(s), alert identifier(s), priority indicator(s), status indicator(s), description(s), date(s) created, and associated data that is configured for association with, for example, generating and/or outputting an external service alert aggregation interface component 304, and to support the operations of the external service alert aggregation interface circuitry 210 and the remaining circuitry. Additionally or alternatively, in some embodiments, external service alert aggregation interface circuitry 210 utilizes input/output circuitry 208 to facilitate user output (e.g., causing rendering of one or more user interface(s) such as an external service alert aggregation interface component 304), and/or to receive user input (e.g., user clicks, user taps, keyboard interactions, user gesture, and/or the like). Additionally or alternatively still, in some embodiments, the external service alert aggregation interface circuitry 210 utilizes communications circuitry 206 to initiate transmissions to another computing device, receive transmissions from another computing device, communicate signals between the various sets of circuitry as depicted, and/or the like.

Accordingly, non-transitory computer readable storage media can be configured to store firmware, one or more application programs, and/or other software, which include instructions and/or other computer-readable program code portions that can be executed to control processors of the components of external service alert aggregation interface component server 200 to implement various operations, including the examples shown herein. As such, a series of computer-readable program code portions may be embodied in one or more computer program products and can be used, with a device, external service alert aggregation interface component server 200, database, and/or other programmable apparatus, to produce the machine-implemented processes discussed herein. It is also noted that all or some of the information discussed herein can be based on data that is received, generated and/or maintained by one or more components of the external service alert aggregation interface component server 200. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied on the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded into a computer, processor or other programmable apparatus's circuitry to produce a machine, such that the computer, processor, or other programmable circuitry that execute the code on the machine creates the means for implementing various functions, including those described herein in connection with the components of external service alert aggregation interface component server 200 and client devices 101A-101N.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device 101A-101N (e.g., for purposes of displaying information/data to and receiving user input from a user interacting with a client device 101A-101N or an admin user interacting with an admin device). Information/data generated at the client device 101A-101N (e.g., as a result of the user interaction with an admin device) can be received from the client device 101A-101N (e.g., client device or admin device) at the server.

In various embodiments of the present disclosure, an apparatus (e.g., external service alert aggregation interface component server 200) is configured to generate and output an external service alert aggregation interface component 304 in a project management system 104. FIG. 3 illustrates an example external service alert aggregation interface component 304 structured in accordance with various embodiments of the subject disclosure. In a non-limiting example, the depicted external service alert aggregation interface component 304 is rendered to the project management user interface 300. In some embodiments, the project management user interface 300 comprises one or more of an external service alert aggregation interface components 304, one or more team task interface components 302, a user identifier filter engagement component 306, an external service active alert engagement component 308, and/or an external service active incident engagement component 310.

Depictions of the external service alert aggregation interface component 304, team task interface component 302, user identifier filter engagement component 306, external service active alert engagement component 308, and external service active incident engagement component 310 are illustrated for purposes of illustration of example embodiments and not of limitation. Other suitable variations of arranging or rendering the interface components and engagement components to the project management user interface 300 are also contemplated by this disclosure as will be apparent to one of ordinary skill in the art.

An example team task interface component is shown in box 302. The project management user interface 300, comprises a plurality of team task interface components 302. In this example embodiment, each of the team task interface components 302 is associated with a user identifier and a team identifier. In some examples, each team task interface component 302 indicates a task assigned to a team associated with the team identifier. The depicted team task interface components 302 are sorted into groups (or columns as shown here) describing tasks that have not been started (To Do), tasks in progress (In Progress), and already completed tasks (Done).

Additionally or alternatively, in some embodiments, the user identifier and team identifier are associated with an active user. For example, a client device 101A-101N may receive or access the user identifier or team identifier. To provide further context, the user identifier or team identifier may be received remotely, via wireless communication or tethered communication, or directly, via input into one of the client devices 101A-101N. In some embodiments, the user may have a remote device, such as a mobile device that interacts with the client devices 101A-101N to transmit a user identifier and/or a team identifier to authenticate the user. In another example, a user may simply provide login credentials through the interface of their client device 101A-101N. The client device 101A-101N then provides and/or transmits the user identifier and/or team identifier to the apparatus (e.g., external service alert aggregation interface component server 106, etc.).

In one or more example embodiments the project management user interface 300 further comprises an external service alert aggregation interface component 304. In this example embodiment, the external service alert aggregation interface component 304 uses external service alert data comprising external service active alert data and external service active incident data. In example embodiments, the external service alert aggregation interface component 304 shows a number of active alerts and a number of active incidents for which data was retrieved from external service alert data repository 110 and/or external service alert data repository 114 based on a user identifier and a team identifier. In other embodiments, the external service alert aggregation interface may show only a number of active alerts or only a number of active incidents associated with an external service alert data repository 110 and/or an external service alert data repository 114 based on a user identifier and a team identifier.

In some embodiments, the apparatus (e.g., external service alert aggregation interface component server 200) is configured to generate and output such an external service alert aggregation interface component 304 for rendering to the project management user interface 300 as described herein. In some embodiments, the external service alert aggregation interface component 304 may be toggled on and off by a user (e.g., based on settings within a project management system 104).

In various example embodiments, the external service alert aggregation interface component 304 comprises both an external service active alert engagement component 308 and an external service active incident engagement component 310. In example embodiments, the external service active alert engagement component 308 is configured to cause retrieval of external service active alert data in response to user engagement. In one or more example embodiments, the external service active incident engagement component 310 is configured to cause retrieval of external service active incident data in response to user engagement. In various embodiments, the external service alert aggregation interface component server 200 (e.g., the external service active alert engagement component 308 and/or the external service active incident engagement component 310) causes retrieval of such external service active incident data and external service active alert data from an external service alert data repository 110 and/or an external service alert data repository 114.

The project management user interface 300 further comprises a user identifier filter engagement component 306. In response to a user engagement with the user identifier filter engagement component 306, the project management user interface 300 is refreshed and replaced with a user focused project management user interface. In various embodiments, the external service alert aggregation interface component server 200 causes the user focused project management user interface to be output for rendering in the project management system 104.

In further embodiments, in response to a user engagement with user identifier filter engagement component 306, the external service alert aggregation interface component server 200 causes the team task interface components 302 to refresh and be replaced with user task interface components that are associated with a particular user identifier. In one or more example embodiments, the external service alert aggregation interface component 304 is replaced with a user focused external service alert aggregation interface component in response to user engagement with the user identifier filter engagement component 306. In various example embodiments, the external service active alert engagement component 308 is replaced with a user focused external service active alert engagement component in response to user engagement with the user identifier filter engagement component 306. In one or more embodiments, the external service active incident engagement component 310 is replaced with a user focused external service active incident engagement component in response to user engagement with the user identifier filter engagement component 306. In various embodiments, replacement functionality involving one or more of these components is provided by external service alert aggregation interface component server 200.

In some examples, in response to a user engagement with a user identifier filter engagement component 306, the external service alert aggregation interface component server 200 can query the external service alert data repository 110 and/or the external service alert data repository 114 again, based on only a user identifier. The query is advantageous in that any new user focused external service alert data would be reflected in at least the user focused project management user interface, the user focused external service alert aggregation interface component, and/or user task interface components.

In other example embodiments, the previously retrieved external service alert data from the external service alert data repository 110 and/or the external service alert data repository 114 can be filtered based on the user identifier to create user focused external service alert data. These embodiments may be advantageous in that rendering latency for the project management system 104 is reduced when no new server query is needed. In various embodiments, this functionality is provided by the external service alert aggregation interface component server 200.

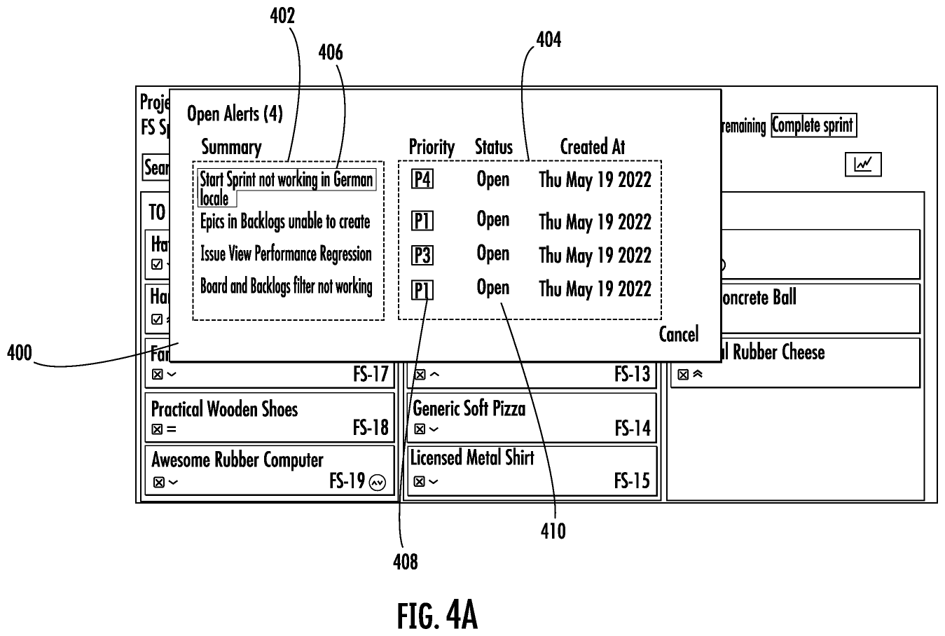

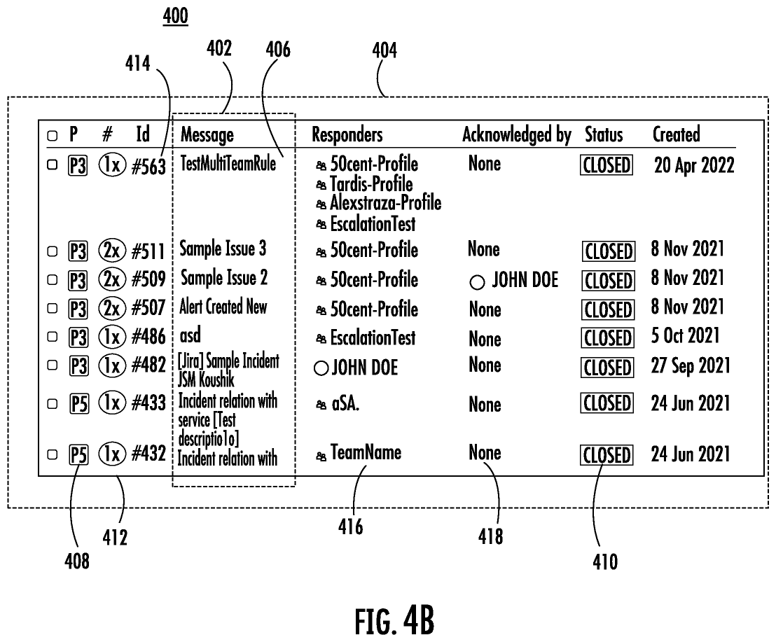

In various embodiments of the present disclosure, an apparatus (e.g., external service alert aggregation interface component server 200) is configured to generate and output an external service alert detail interface component 400 in a project management system 104. FIG. 4A illustrates an external service alert detail interface component 400 structured in accordance with various embodiments of the subject disclosure. In a non-limiting example, the depicted external service alert detail interface component 400 is rendered to the project management user interface 300 as a modal or pop-up that is depicted to at least partly overlap one or more portions of the project management user interface 300 shown in FIG. 3. In some embodiments, the external service alert detail interface component 400 comprises one or more of an alert list interface component 402, an alert details interface component 404, an alert action engagement component 406, an alert priority indicator component 408, and an alert status indicator component 410.

Depictions of the alert list interface component 402, alert details interface component 404, alert action engagement component 406, alert priority indicator component 408, and alert status indicator component 410 are illustrated for purposes of illustration and not of limitation. Other suitable variations of arranging or rendering the interface components and engagement components to the project management user interface 300 are also contemplated by this disclosure as will be apparent to one of ordinary skill in the art.

The external service alert detail interface component 400 shows either active alerts or active incidents based on external service active alert data or external service active incident data. The external service alert detail interface component 400 is generated by an apparatus (e.g., external service alert aggregation interface component server 200) in response to user engagement with an external service active alert engagement component 308 or an external service active incident engagement component 310.

In one or more example embodiments the external service alert detail interface component 400 further comprises an alert list interface component 402 and an alert details interface component 404. In further embodiments, the alert list interface component 402 further comprises an alert action engagement component 406 for each active alert or active incident associated with external service active alert data or external service active incident data. In an example embodiment, the alert list interface component 402 lists out active alerts and active incidents each associated with a with specific alert identifier. In various embodiments, in the alert list interface component 402, the active alerts or active incidents are listed in an order determined by settings selected by a user. In various embodiments, the alert action engagement component 406 is associated with an alert identifier for a particular external service alert.

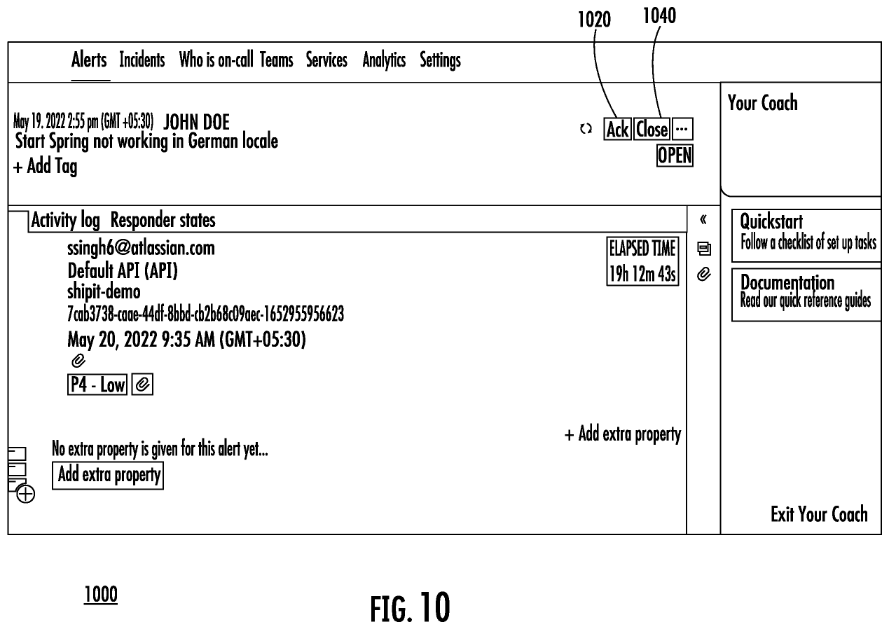

In response to a user engagement with an alert action engagement component 406 associated with a particular alert identifier, the apparatus (e.g., external service alert aggregation interface component server 200) is configured to identify the alert identifier associated with the selected alert action engagement component 406, cause retrieval of selected external service alert data from the external service alert data repository 110 and/or the external service alert data repository 114 based on the selected alert identifier, and generate an external service alert modification interface component 1000. In example embodiments, based on the external service alert data, the apparatus (e.g., external service alert aggregation interface component server 200) is further configured to output the external service alert modification interface component 1000 for rendering to the project management user interface 300. The external service alert modification interface component 1000 is further illustrated in FIG. 10.

In one or more example embodiments, alert details interface component 404 further comprises alert priority indicator components 408 and alert status indicator components 410. An alert priority indicator component 408 is associated with a particular alert identifier corresponding to the external service alert shown in the opposing alert action engagement component 406. In various embodiments, the priority of a particular external service alert shows how urgent or important an external service alert is. This can be helpful to the user in order to triage workflows accordingly.

In various embodiments, the alert status indicator component 410 is included in the alert details interface component 404. In one or more embodiments, the alert status indicator component 410 reflects whether further action should be taken by a user regarding the particular external service alert associated with the alert status indicator component 410.

FIG. 4B illustrates an alternative structure of external service alert detail interface component 400 in accordance with various embodiments of the subject disclosure. In some embodiments, the external service alert detail interface component 400 comprises one or more of an alert list interface component 402, an alert details interface component 404, an alert action engagement component 406, an alert priority indicator component 408, an alert status indicator component 410, an alert reception quantity indicator component 412, an alert identifier indicator component 414, an alert responder indicator component 416, and an alert acknowledgment indicator component 418.

Depictions of the alert list interface component 402, alert details interface component 404, alert action engagement component 406, alert priority indicator component 408, alert status indicator component 410, alert reception quantity indicator component 412, alert identifier indicator component 414, alert responder indicator component 416, and alert acknowledgment indicator component 418 are illustrated for purposes of illustration and not of limitation. In various embodiments, alert list interface component 402 is outputted within alert details interface component 404. Other suitable variations of arranging or rendering the interface components and engagement components to the project management user interface 300 are also contemplated by this disclosure as will be apparent to one of ordinary skill in the art. In various embodiments, the alert details interface component 404 includes other information such as the date at which the alert was created, the team identifier associated with the alert, a description of the external service alert, or other information related to external service alerts that may be pertinent to an end user.

In various embodiments, the alert reception quantity indicator component 412 is included in the alert details interface component 404. In one or more embodiments, the alert reception quantity indicator component 412 reflects a number of times that an external service alert has been received by particular users or teams associated with a particular user identifiers or team identifiers. Each alert reception quantity indicator component 412 is associated with a particular alert identifier.

In various embodiments, the alert identifier indicator component 414 is included in the alert details interface component 404. In one or more embodiments, the alert identifier indicator component 414 indicates the alert identifier associated with a particular external service alert reflected in the alert list interface component 402. The alert identifier indicator component 414 may correspond to an external service active alert or an external service active incident.

In various embodiments, the alert responder indicator component 416 is included in the alert details interface component 404. In one or more embodiments, the alert responder indicator component 416 indicates particular users or teams associated with particular user identifiers or team identifiers that are responsible for responding to a particular external service alert listed in alert list interface component 402.

In various embodiments, the alert acknowledgment indicator component 418 is included in the alert details interface component 404. In one or more embodiments, the alert acknowledgment indicator component 418 indicates whether a particular external service alert reflected in the alert list interface component 402 has been acknowledged by a user. In one or more embodiments, the alert acknowledgment indicator component 418 indicates the user that has acknowledged the external service alert. In one or more embodiments, the user that has acknowledged the external service alert is identified by a user identifier.

### Example Operations Performed

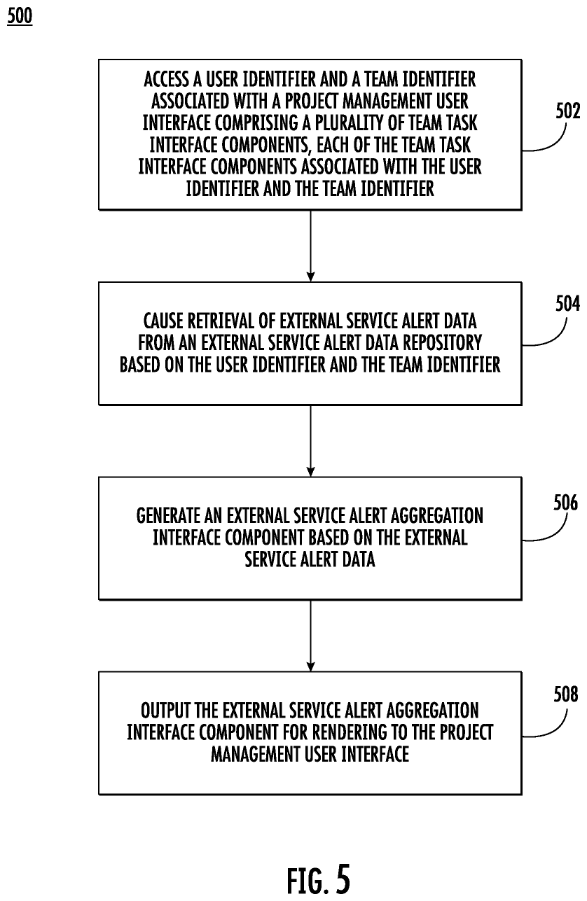

Having described the apparatus, system, and exemplary circuitry comprising embodiments of the present disclosure, it should be understood that the apparatus may proceed to output an external service alert aggregation interface component 304 in a project management system 104 in a number of ways. Turning now to FIG. 5, a method 500 is illustrated for outputting an external service alert aggregation interface component 304 in a project management system 104. The operations illustrated in FIG. 5 may, for example, be performed by, with the assistance of, and/or under the control of an apparatus (e.g., external service alert aggregation interface component server 200), as described above. In this regard, performance of the operations may invoke one or more of memory 204, processor 202, input/output circuitry 208, communications circuitry 206, and/or external service alert aggregation interface circuitry 210.

Block 502 includes means, such as the processor 202, communications circuitry 206, input/output circuitry 208, external service alert aggregation interface circuitry 210, or the like, for accessing a user identifier and a team identifier. The user identifier and the team identifier are associated with a project management user interface 300 comprising a plurality of team task interface components 302. Each of the team task interface components 302 are associated with the user identifier and the team identifier. In one or more embodiments, the functionality of block 502 is performed by the external service alert aggregation interface component server as illustrated in FIGS. 1, 2, and 9.

Block 504 includes means, such as the processor 202, communications circuitry 206, input/output circuitry 208, external service alert aggregation interface circuitry 210, or the like, for causing retrieval of external service alert data from an external service alert data repository 110 and/or external service alert data repository 114. The retrieval of the external service alert data from the external service alert data repository 110 and/or the external service alert data repository 114 is based on the user identifier and the team identifier. In one or more embodiments, the functionality of block 504 is performed by the external service alert aggregation interface component server 106 as illustrated in FIGS. 1, 2, and 9.

Block 506 includes means, such as the processor 202, communications circuitry 206, external service alert aggregation interface circuitry 210, or the like, for generating an external service alert aggregation interface component 304 based on the external service alert data. In various embodiments, the external service alert data is retrieved from the external service alert data repository. In one or more embodiments, the functionality of block 506 is performed by the external service alert aggregation interface component server as illustrated in FIGS. 1, 2, and 9.

Block 508 includes means, such as the processor 202, communications circuitry 206, input/output circuitry 208, external service alert aggregation interface circuitry 210, or the like, for outputting the external service alert aggregation interface component 304 for rendering to a project management user interface 300. In one or more embodiments, the functionality of block 508 is performed by the external service alert aggregation interface component server 106 as illustrated in FIGS. 1, 2, and 9.

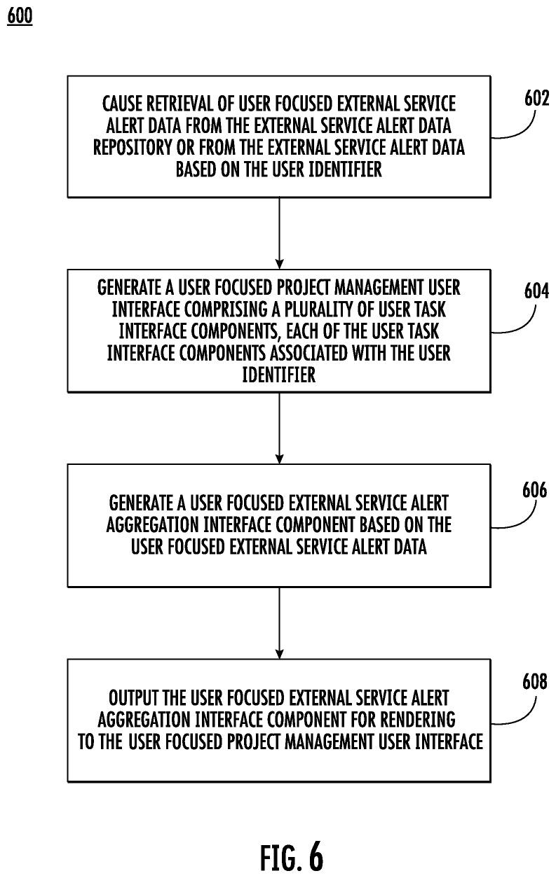

In one or more embodiments, this method 500 may be modified by using only a user identifier, as illustrated in FIG. 6 depicting method 600. For example, this may occur after a user engagement with a user identifier filter engagement component 306 in a project management user interface 300.

Turning now to FIG. 6, a method 600 is provided for outputting a user focused external service alert aggregation interface component to a user focused project management user interface in one or more embodiments. The operations illustrated in FIG. 6 may, for example, be performed by, with the assistance of, and/or under the control of an apparatus (e.g., external service alert aggregation interface component server 200), as described above. In this regard, performance of the operations may invoke one or more of memory 204, processor 202, input/output circuitry 208, communications circuitry 206, and/or external service alert aggregation interface circuitry 210. This is caused in response to user engagement with a user identifier filter engagement component 306 in a project management user interface 300.

Block 602 includes means, such as the processor 202, communications circuitry 206, input/output circuitry 208, external service alert aggregation interface circuitry 210, or the like, for causing retrieval of user focused external service alert data.

In one or more embodiments, user focused external service alert data is retrieved from an external service alert data repository (e.g., external service alert data repository 110 and/or external service alert data repository 114) based on a user identifier. Retrieving the user focused external service alert data from the external service alert data repository can be advantageous in that new external service alert data is reflected in an updated user focused external service alert aggregation interface component, which is rendered to the user focused project management user interface. In other example embodiments, user focused external service alert data is retrieved from previously retrieved external service alert data based on a user identifier. This may be advantageous in that faster rendering of user focused external service alert data will be possible. In one or more embodiments, the functionality of block 602 is performed by the external service alert aggregation interface component server as illustrated in FIGS. 1, 2, and 9.

Block 604 includes means, such as the processor 202, communications circuitry 206, external service alert aggregation interface circuitry 210, or the like, for generating a user focused project management user interface. The user focused project management interface comprises a plurality of user task interface components. Each of the user task interface components is associated with the user identifier. In one or more embodiments, the functionality of block 604 is performed by the external service alert aggregation interface component server 106 as illustrated in FIGS. 1, 2, and 9.

Block 606 includes means, such as the processor 202, communications circuitry 206, external service alert aggregation interface circuitry 210, or the like, for generating a user focused external service alert aggregation interface component based on the user focused external service alert data. In one or more example embodiments, the user focused external service alert aggregation interface component has both a user focused external service active alert engagement component 308 and a user focused external service active incident engagement component 310. In one or more example embodiments, the user focused external service alert aggregation interface component is based on both user focused external service active alert data and user focused external service active incident data. In one or more embodiments, the functionality of block 606 is performed by the external service alert aggregation interface component server as illustrated in FIGS. 1, 2, and 9.

Block 608 includes means, such as the processor 202, communications circuitry 206, input/output circuitry 208, external service alert aggregation interface circuitry 210, or the like, for outputting the user focused external service alert aggregation interface component for rendering to a user focused project management user interface. In one or more embodiments, the user focused external service alert aggregation interface component is output based on settings that can be modified by a user of the user focused project management user interface. In one or more embodiments, the functionality of block 608 is performed by the external service alert aggregation interface component server 106 as illustrated in FIGS. 1, 2, and 9.

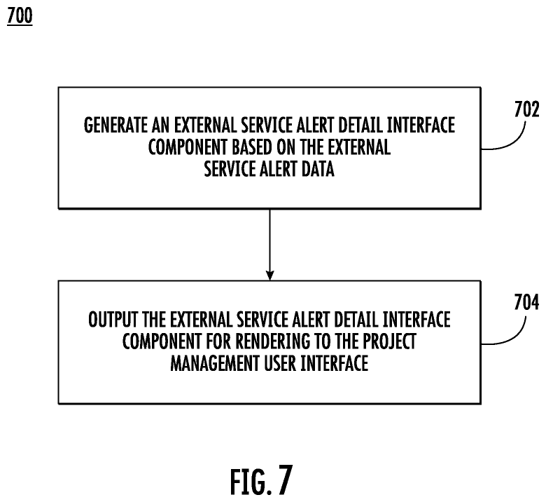

Turning now to FIG. 7, a method 700 is provided for outputting an external service alert detail interface component 400 for rendering to a project management user interface 300. The operations illustrated in FIG. 7 may, for example, be performed by, with the assistance of, and/or under the control of an apparatus (e.g., external service alert aggregation interface component server 200), as described above. In this regard, performance of the operations may invoke one or more of memory 204, processor 202, input/output circuitry 208, communications circuitry 206, and/or external service alert aggregation interface circuitry 210. In one or more embodiments, method 700 is initiated in response to a user engagement with an external service active alert engagement component 308 or an external service active incident engagement component 310.

Block 702 includes means, such as the processor 202, communications circuitry 206, external service alert aggregation interface circuitry 210, or the like, for generating an external service alert detail interface component 400 based on external service alert data. In various embodiments, the external service alert data is fetched from an external service alert data repository (e.g., external service alert data repository 110 and/or external service alert data repository 114). In one or more embodiments, the external service alert data may be external service active alert data and/or external service active incident data. In one or more embodiments, the functionality of block 702 is performed by the external service alert aggregation interface component server as illustrated in FIGS. 1, 2, and 9.

Block 704 includes means, such as the processor 202, communications circuitry 206, input/output circuitry 208, external service alert aggregation interface circuitry 210, or the like, for outputting the external service alert detail interface component 400 for rendering to a project management user interface 300. In one or more embodiments, the functionality of block 704 is performed by the external service alert aggregation interface component server 106 as illustrated in FIGS. 1, 2, and 9.

In various example embodiments, in response to a user engagement with a user identifier filter engagement component 306 followed by user engagement with a user focused external service active alert engagement component 308 or a user focused external service active incident engagement component 310, a user focused external service alert detail interface component is generated. In one or more embodiments, this functionality is performed by the external service alert aggregation interface component server as illustrated in FIGS. 1, 2, and 9. In this example embodiment, the external service alert aggregation interface component server 200 generates the user focused external service alert detail interface component based on user focused external service alert data (e.g., user focused external service active alert data and/or user focused external service active incident data). In this example embodiment, the user focused external service alert detail interface component is outputted for rendering to a user focused project management user interface. In one or more embodiments, this functionality is performed by the external service alert aggregation interface component server 106 as illustrated in FIGS. 1, 2, and 9.

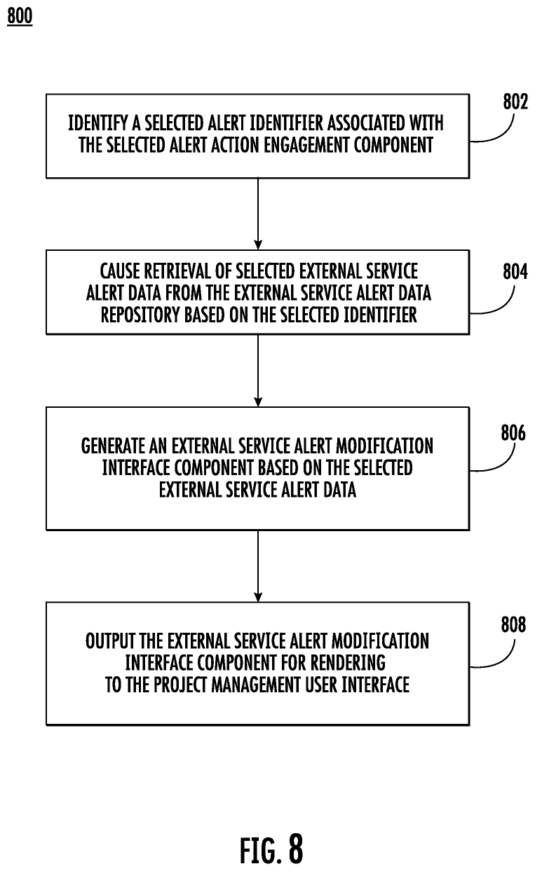

Turning now to FIG. 8, a method 800 is provided for outputting an external service alert modification interface component 1000 for rendering to a project management user interface 300. The operations illustrated in FIG. 8 may, for example, be performed by, with the assistance of, and/or under the control of an apparatus (e.g., external service alert aggregation interface component server 200), as described above. In this regard, performance of the operations may invoke one or more of memory 204, processor 202, input/output circuitry 208, communications circuitry 206, and/or external service alert aggregation interface circuitry 210.

Block 802 includes means, such as the processor 202, communications circuitry 206, external service alert aggregation interface circuitry 210, or the like, for identifying a selected alert identifier associated with a selected alert action engagement component 406. In some examples, the selected alert action engagement component 406 is part of an alert list interface component 402 in an external service alert detail interface component 400. The specific alert identifier is determined based on a user engagement with a specific alert action engagement component 406. In one or more embodiments, the functionality of block 802 is performed by the external service alert aggregation interface component server as illustrated in FIGS. 1, 2, and 9.

Block 804 includes means, such as the processor 202, communications circuitry 206, input/output circuitry 208, external service alert aggregation interface circuitry 210, or the like, for causing retrieval of a selected external service of selected external service alert data from the external service alert data repository (e.g., external service alert data repository 110 and/or external service alert data repository 114) based on the selected alert identifier. Retrieval from an external service alert data repository may be advantageous by allowing use of updated external service alert data. In one or more example embodiments, a method alternatively provides means for filtering selected external service alert data from previously retrieved external service alert data based on the alert identifier, which may be advantageous by allowing faster rendering with no new server query is required. In one or more embodiments, the functionality of block 804 is performed by the external service alert aggregation interface component server 106 as illustrated in FIGS. 1, 2, and 9.

Block 806 includes means, such as the processor 202, communications circuitry 206, external service alert aggregation interface circuitry 210, or the like, for generating an external service alert modification interface component 1000 based on the selected external service alert data. In one or more embodiments, the external service alert modification interface component 1000 further comprises an alert modification action engagement component 1020 and an alert modification status engagement component 1040. In one or more embodiments, the functionality of block 806 is performed by the external service alert aggregation interface component server as illustrated in FIGS. 1, 2, and 9.

Block 808 includes means, such as the processor 202, communications circuitry 206, input/output circuitry 208, external service alert aggregation interface circuitry 210, or the like, for outputting the external service alert modification interface component 1000 for rendering to a project management user interface 300. In one or more embodiments, the functionality of block 808 is performed by the external service alert aggregation interface component server 106 as illustrated in FIGS. 1, 2, and 9.

In one or more example embodiments, a similar method can be performed after a user has selected a user identifier filter engagement component 306. In response to a user engagement with user identifier filter engagement component 306, the method provides means, such as the processor 202, communications circuitry 206, input/output circuitry 208, external service alert aggregation interface circuitry 210, or the like, for identifying a selected alert identifier based on a user engagement with a selected alert action engagement component 406 associated with a user identifier. In one or more embodiments, this functionality is performed by the external service alert aggregation interface component server as illustrated in FIGS. 1, 2, and 9.

In this example embodiment, block 804 provide means, such as the processor 202, communications circuitry 206, input/output circuitry 208, external service alert aggregation interface circuitry 210, or the like, for causing retrieval of selected external service alert data from user focused external service alert data or from an external service alert data repository. In various embodiments, selected external alert data is retrieved from previously retrieved user focused external service alert data. This is advantageous in that no new server query is required, allowing for faster rendering of an external service alert modification interface component 1000. In other embodiments, selected external service alert data is retrieved from an external service alert data repository based on an alert identifier and a user identifier. This may be advantageous in that the retrieved selected external service alert data reflects the latest updates from the external service alert data repository. In one or more embodiments, this functionality is performed by the external service alert aggregation interface component server 106 as illustrated in FIGS. 1, 2, and 9.

In this example embodiment, block 806 would provide means, such as the processor 202, communications circuitry 206, input/output circuitry 208, external service alert aggregation interface circuitry 210, or the like, for generating an external service alert modification interface component 1000 based on the selected external service alert data. In this example embodiment, the method outputs the external service alert modification interface component 1000 for rendering to a user focused project management user interface. In one or more embodiments, this functionality is performed by the external service alert aggregation interface component server as illustrated in FIGS. 1, 2, and 9.

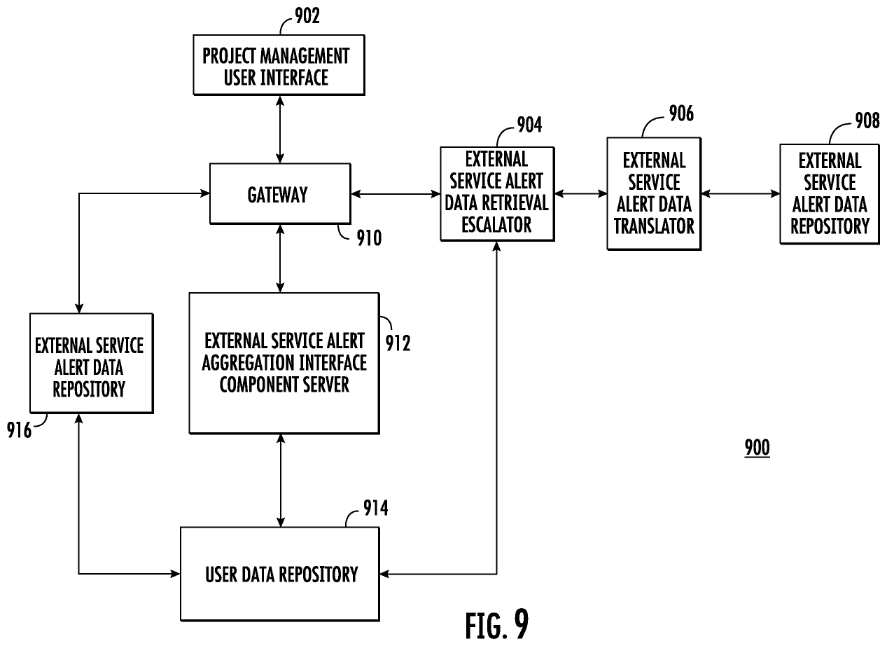

Turning now to FIG. 9, a schematic architecture of an example system 900 is provided that may be used for generating an external service alert aggregation interface component 304 as shown in FIG. 3. In various embodiments, the system 900 includes an external service alert aggregation interface component server 912 that is configured to store and track configuration information associated with queries for external service active incident data and external service active alert data.

In various embodiments, external service alert aggregation interface component server 912 is configured to access a user identifier and a team identifier associated with a project management user interface 902 comprising a plurality of team task interface components 302, each of the team task interface components 302 associated with the user identifier and the team identifier. In one or more embodiments, the external service alert aggregation interface component server 912 is further configured to cause retrieval of external service alert data from an external service alert data repository 908 and/or an external service alert data repository 916 based on the user identifier and the team identifier. In example embodiments, the external service alert data comprises external service active alert data and external service active incident data.

In one or more embodiments, the external service alert aggregation interface component server 912 is further configured to generate an external service alert aggregation interface component 304 based on the external service alert data. In example embodiments, the external service alert aggregation interface component 304 comprises an external service active alert engagement component 308 and an external service active incident engagement component 310. In further embodiments, external service alert aggregation interface component server 912 is configured to output the external service alert aggregation interface component 304 for rendering to the project management user interface 902.

In one or more embodiments, in response to a user engagement with the external service active alert engagement component 308 or the external service active incident engagement component 310, the external service alert aggregation interface component server 912 is further configured to generate an external service alert detail interface component 400 based on the external service alert data and output the external service alert detail interface component 400 for rendering to project management user interface 902. In one or more embodiments the external service alert detail interface component 400 comprises an alert list interface component 402 and an alert details interface component 404. In various embodiments, the alert details interface component 404 comprises an alert priority indicator component 408 and an alert status indicator component 410.

In one or more embodiments, the alert list interface component 402 comprises one or more alert action engagement components, each associated with an alert identifier. In response to a user engagement with a selected alert action engagement component 406, the external service alert aggregation interface component server 912 is configured to identify a selected alert identifier associated with the selected alert action engagement component 406, cause retrieval of selected external service alert data from external service alert data repository 908 and/or external service alert data repository 916 based on the alert identifier, generate an external service alert modification interface component 1000 based on the selected external service alert data, and output the external service alert modification interface component 1000 for rendering to project management user interface 902.

In various embodiments, in response to a user engagement with a user identifier filter engagement component 306 in project management user interface 902, the external service alert aggregation interface component server 912 is further configured to cause retrieval of user focused external service alert data from the external service alert data repository 916 and/or the external service alert data repository 908. For example, the user focused external service alert data may be retrieved with an external service alert data retrieval escalator 904. In alternative embodiments, the external service alert aggregation interface component server 912 is configured to cause retrieval of user focused external service alert data from previously retrieved external service alert data based on the user identifier.

In one or more embodiments, the external service alert aggregation interface component server 912 is configured to generate a user focused project management user interface comprising plurality of user task interface components, each of the user task interface components associated with the user identifier. In various embodiments, external service alert aggregation interface component server 912 is further configured to generate a user focused external service alert aggregation interface component based on the user focused external service alert data. In one or more embodiments, the external service alert aggregation interface component server 912 is further configured to output the user focused external service alert aggregation interface component for rendering to the user focused project management user interface.

External service alert data (e.g., external service active incident data or external service active alert data) may be fetched based on a number of criteria including but not limited to user identifier, team identifier and alert identifier. In some examples, such external service alert data may be fetched from external service alert data repository 908 or external service alert data repository 916.

In various embodiments project management user interface 902 is configured to integrate and display development and operations task and data in various embodiments (e.g., external service active incident data or external service active alert data, which may be retrieved from external service alert data repository 908 or external service alert data repository 916). In one or more embodiments, project management user interface 902 displays the external service active incident data or external service active alert data in an external service alert aggregation interface component 304. In various embodiments, the project management user interface 902 is configured to display the external service active incident data or external service active alert data in an external service active alert engagement component 308 or external service active incident engagement component 310. In various embodiments, such external service active incident data or external service active alert data is modified in response to user engagement with the project management user interface 902. In one or more embodiments, the project management user interface 902 further comprises a user identifier filter engagement component 306.

In various embodiments, the project management user interface 902 is configured to issue list queries to external service alert data repository 916 to display alerts or incidents as part of an alert list interface component 402. For example, the project management user interface 902 can be configured to fetch and display active alerts or active incidents based on data or metadata including but not limited to priority indicator(s), description(s), status indicator(s), team identifier(s), user identifier(s), alert identifier(s), or other properties or fields.

In various embodiments, the project management user interface 902 includes a board settings interface containing an alert and incident filter engagement component. In such embodiments, the project management user interface 902 displays external service active alert data or external service active incident data based on interaction with the alert and incident filter engagement component. In various embodiments, incident and alert display settings are stored to a data repository accessible by the external service alert aggregation interface component server 912.

In various embodiments, the project management user interface 902 includes a board settings interface containing a user identifier filter engagement component 306. In such embodiments, the project management user interface 902 displays external service active alert data or external service active incident data tailored to a particular user in response to interaction with the user identifier filter engagement component 306. In various embodiments, the user identifier filter engagement component 306 settings are stored to a data repository accessible by the external service alert aggregation interface component server 912.

In one or more embodiments, the user data repository 914 maintains information about a particular customer's license or plan. For example, the user data repository 914 maintains information about the region in which customer data exists.

In various embodiments, the gateway 910 verifies whether a particular customer has a license to external service alert data repository 916. (i.e., whether a particular user has access to external service alert data repository 916). In one or more embodiments the gateway 910 authorizes external service active alert data or external service active incident data to pass between the project management user interface 902 and the external service alert data retrieval escalator 904. In various embodiments, the gateway 910 authorizes external service active incident data or external service active alert data to pass between the project management user interface 902 and the external service alert data repository 916. In various embodiments, the gateway 910 authorizes saved settings for external service active incident data and external service active alert data to pass between the project management user interface 902 and the external service alert aggregation interface component server 912.

In one or more embodiments, the external service alert data retrieval escalator 904 delivers customized queries from the project management user interface 902 to external service alert data repository 908. For example, the project management user interface 902 can be configured to fetch and display active alerts or active incidents based on data or metadata retrieved based on these queries including but not limited to alert identifier(s), team identifier(s), priority indicator(s), description(s), status indicator(s), owner, and other custom properties.

In one or more embodiments, the external service alert data translator 906 is configured to translate external service active alert data and/or external service active incident data passing between the project management user interface 902 and external service alert data repository 908. For example, external service alert data translator 906 may translate external service alert data such that it can be displayed as part of project management user interface 902. Such translation operations may include data normalization, mapping data elements to a known or common object schema, data verification, data validation, and other similar operations. External service alert data translator 906 may be configured to convert external service alert data from one syntax to another or one data structure to another. In some examples, external service alert data translator 906 may perform substitutions on the external service alert data in order to configure it for display as part of project management user interface 902.

Turning now to FIG. 10, an external service alert modification interface component 1000 is illustrated. In various embodiments, the external service alert modification interface component 1000 displays external service alert data associated with a particular alert identifier. In example embodiments, the external service alert data comprises external service active incident data or external service active alert data associated with a particular alert identifier.

In an example embodiment, the external service alert aggregation interface component server 912 modifies external service alert data in response to a user engagement with the alert modification action engagement component 1020. This modified external service alert data may comprise selected external service alert data (e.g., selected external service active alert data or selected external service active incident data). In one or more embodiments, in response to user engagement with the alert modification action engagement component 1020, the selected external service alert data is modified and pushed to an external service alert data retrieval system.

In an example embodiment, the external service alert aggregation interface component server 912 modifies an external service alert aggregation interface component 304 based on the user interaction with the alert modification status engagement component 1040. In an example embodiment, the external service alert aggregation interface component server 912 may modify an external service alert detail interface component 400 to no longer reflect the external service alert associated with the particular alert identifier that generated the external service alert modification interface component 1000.

In this example embodiment, the external service alert modification interface component 1000 is closed in response to user engagement with the alert modification status engagement component 1040. In various embodiments, user engagement with the alert modification status engagement component 1040 returns the project management user interface 300 to the plurality of team task interface components 302, the external service alert aggregation interface component 304, and the user identifier filter engagement component 306. In other example embodiments, user engagement with the alert modification status engagement component 1040 returns the project management user interface 300 to the user focused project management interface comprising a plurality of user task interface components, a user focused external service alert aggregation interface component, and a user identifier filter engagement component 306.

FIGS. 5-8 thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the external service alert aggregation interface component server 200 and executed by a processor 202 of the external service alert aggregation interface component server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions sorted in the computer-readable memory produce an article of manufacture, the execution of which implements the functions specified in the flowchart blocks. The computer program instructions may also be loaded onto a computer or other programmable apparatus to produce a computer-implemented process such that the instructions executed on the computer or other programmable apparatus provide operations for implementing the functions specified in the flowcharts.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of any inventions or of what may be claimed, but rather as description of features specific to particular embodiments of particular inventions. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitations.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

That which is claimed:

1. An apparatus for outputting an external service alert aggregation interface component in a project management system, the apparatus comprising at least one processor, and at least one non-transitory memory including program code, the at least one non-transitory memory and the program code configured to, with the at least one processor, cause the apparatus to:
access a user identifier and a team identifier associated with a project management user interface comprising a plurality of team task interface components, each of the team task interface components associated with the user identifier and the team identifier;
cause retrieval of external service alert data from an external service alert data repository based on the user identifier and the team identifier;
generate the external service alert aggregation interface component based on the external service alert data; and
output the external service alert aggregation interface component for rendering to the project management user interface.

2. The apparatus of claim 1, wherein the external service alert data comprises external service active alert data and external service active incident data.

3. The apparatus of claim 1, wherein the project management user interface further comprises a user identifier filter engagement component.

4. The apparatus of claim 3, wherein in response to user engagement with the user identifier filter engagement component, the at least one non-transitory memory and the program code are further configured to, with the at least one processor, cause the apparatus to:
cause retrieval of user focused external service alert data from the external service alert data repository or from the external service alert data based on the user identifier;
generate a user focused project management user interface comprising a plurality of user task interface components, each of the user task interface components associated with the user identifier;
generate a user focused external service alert aggregation interface component based on the user focused external service alert data; and
output the user focused external service alert aggregation interface component for rendering to the user focused project management user interface.

5. The apparatus of claim 1, wherein the external service alert aggregation interface component comprises an external service active alert engagement component and an external service active incident engagement component.

6. The apparatus of claim 5, wherein in response to user engagement with the external service active alert engagement component or the external service active incident engagement component, the at least one non-transitory memory and the program code are further configured to, with the at least one processor, cause the apparatus to:
generate an external service alert detail interface component based on the external service alert data; and
output the external service alert detail interface component for rendering to the project management user interface.

7. The apparatus of claim 6, wherein the external service alert detail interface component comprises an alert list interface component and an alert details interface component.

8. The apparatus of claim 7, wherein the alert details interface component comprises an alert priority indicator component and an alert status indicator component.

9. The apparatus of claim 7, wherein the list interface component comprises one or more alert action engagement components each associated with an alert identifier, wherein in response to user engagement with a selected alert action engagement component, the at least one non-transitory memory and the program code are further configured to, with the at least one processor, cause the apparatus to:
identify a selected alert identifier associated with the selected alert action engagement component;
cause retrieval of selected external service alert data from the external service alert data repository based on the selected alert identifier;
generate an external service alert modification interface component based on the selected external service alert data; and
output the external service alert modification interface component for rendering to the project management user interface.

10. A computer-implemented method comprising:
accessing a user identifier and a team identifier associated with a project management user interface comprising a plurality of team task interface components, each of the team task interface components associated with the user identifier and the team identifier;
causing retrieval of external service alert data from an external service alert data repository based on the user identifier and the team identifier;
generating an external service alert aggregation interface component based on the external service alert data; and
outputting the external service alert aggregation interface component for rendering to the project management user interface.

11. The computer-implemented method of claim 10, wherein the external service alert data comprises external service active alert data and external service active incident data.

12. The computer-implemented method of claim 10, wherein the project management user interface further comprises a user identifier filter engagement component.

13. The computer-implemented method of claim 12, further comprising:
in response to user engagement with the user identifier filter engagement component:
causing retrieval of user focused external service alert data from the external service alert data repository or from the external service alert data based on the user identifier;
generating a user focused project management user interface comprising a plurality of user task interface components, each of the user task interface components associated with the user identifier;
generating a user focused external service alert aggregation interface component based on the user focused external service alert data; and
outputting the user focused external service alert aggregation interface component for rendering to the user focused project management user interface.

14. The computer-implemented method of claim 10, wherein the external service alert aggregation interface component comprises an external service active alert engagement component and an external service active incident engagement component.

15. The computer-implemented method of claim 14, further comprising:
in response to user engagement with the external service active alert engagement component or the external service active incident engagement component:
generating an external service alert detail interface component based on the external service alert data; and
outputting the external service alert detail interface component for rendering to the project management user interface.

16. The computer-implemented method of claim 15, wherein the external service alert detail interface component comprises an alert list interface component and an alert details interface component.

17. The computer-implemented method of claim 16, wherein the alert details interface component comprises an alert priority indicator component and an alert status indicator component.

18. The computer-implemented method of claim 16, wherein the list interface component comprises one or more alert action engagement components each associated with an alert identifier, further comprising:
in response to user engagement with a selected alert action engagement component:
identifying a selected alert identifier associated with the selected alert action engagement component;
causing retrieval of selected external service alert data from the external service alert data repository based on the selected alert identifier;
generating an external service alert modification interface component based on the selected external service alert data; and
outputting the external service alert modification interface component for rendering to the project management user interface.

19. One or more non-transitory computer-readable media storing computer-executable instructions that, when executed by one or more processors, are configured to cause:
accessing a user identifier and a team identifier associated with a project management user interface comprising a plurality of team task interface components, each of the team task interface components associated with the user identifier and the team identifier;
causing retrieval of external service alert data from an external service alert data repository based on the user identifier and the team identifier;
generating an external service alert aggregation interface component based on the external service alert data; and
outputting the external service alert aggregation interface component for rendering to the project management user interface.

20. The one or more non-transitory computer readable media storing computer-executable instructions of claim 19, wherein the external service alert data comprises external service active alert data and external service active incident data.
